(19) United States
(12) Patent Application Publication
(10) Pub. No.: US 2019/0322803 A1
(43) Pub. Date: Oct. 24, 2019

(54) SUSTAINABLE PROCESS FOR PREPARING POLY(LIMONENE)DICARBONATE HAVING HIGH GLASS TRANSITION TEMPERATURE

(71) Applicants: Fundació Institut Català d'Investigació Química (ICIQ), Tarragons (ES); Institució Catalana de Recerca i Estudis Avançats (ICREA), Barcelona (ES)

(72) Inventors: Arjan Kleij, Torredembarra (ES); Àlex Cristofol Martínez, Reus (ES); Nicole Kindermann, Tarragona (ES)

(21) Appl. No.: 16/387,084

(22) Filed: Apr. 17, 2019

Related U.S. Application Data
(60) Provisional application No. 62/659,556, filed on Apr. 18, 2018.

(51) Int. Cl. C08G 64/42; C08G 64/34; C08K 5/14; B01J 31/18; B01J 31/22

(52) U.S. Cl. CPC C08G 64/42; C08G 64/34; C08K 5/14; B01J 2531/31; B01J 31/223; B01J 2531/0238; B01J 31/1805

(57) ABSTRACT

The present invention concerns a process for the preparation of poly(limonene)dicarbonate (PLDC) from poly(limonene)carbonate, proceeding via the epoxidized intermediate, as well as the resulting PLDC products having an unusually high glass transition temperature.

### CROSS REFERENCE TO RELATED APPLICATION

This application claims the benefit of priority to U.S. Provisional Patent Application No. 62/659,556, filed on Apr. 18, 2018, the disclosure of which is hereby expressly incorporated by reference in its entirety.

### FIELD OF THE INVENTION

The present invention concerns the preparation of poly(limonene)dicarbonate (PLDC) from sustainable starting materials, as well as the resulting PLDC products having an unusually high glass transition temperature.

### BACKGROUND OF THE INVENTION

The copolymerization of aliphatic epoxides and CO₂ is a well-established approach towards the synthesis of thermoplastic polymers with properties that mainly depend on the nature of the epoxide monomer. Despite the fact that most reported polycarbonates are based on petroleum derived epoxide monomers such as cyclohexene oxide, propylene oxide and others, recently the attention has been shifting towards the use of (partially) bio-based epoxides as a way to produce polymers with an improved sustainability footprint. In this respect, the use of terpene oxides has yet offered new potential for biomass-derived polycarbonates and polyesters displaying similar or even improved properties compared to fossil fuel based conventional polymers.

Peña Carrodeguas et al. (Chem. Eur. J., 2015, 21, 6115-6122) disclose the copolymerization of limonene oxide (LO) and CO₂ in the presence of PPNX (X═Cl, Br) co-catalysts and an amino-trisphenolate aluminum complex to produce poly(limonene)carbonate (PLC). Further articles to disclose the preparation of PLC include Byrne et al. (C. M. Byrne, S. D. Allen, E. B. Lobkovsky and G. W. Coates, Journal of the American Chemical Society, 2004, 126, 11404-11405), Li et al. (C. Li, R. J. Sablong and C. E. Koning, European Polymer Journal, 2015, 67, 449-458), Rieger et al. (Chem. Sci., 2017, 8, 1876-1882) and Hauenstein et al. (O. Hauenstein, M. Reiter, S. Agarwal, B. Rieger and A. Greiner, Green Chemistry, 2016, 18, 760-770), disclosing the use of zinc diiminate complexes as catalysts to promote the reaction.

Li et al. (Angew. Chem., Int. Ed., 2016, 55, 11572-11576) disclose the polymerization of limonene dioxide to prepare poly(limonene-8,9-oxide carbonate) (PLOC) and the further reaction of PLOC with CO₂ to prepare PLDC. The PLDC prepared according to this method had a glass transition temperature of 146° C.

There is thus still a need for PLDC having higher glass transition temperatures, as well as improved methods for their preparation.

### SUMMARY OF THE INVENTION

In one aspect, the present invention concerns a process for preparing poly(limonene)dicarbonate (PLDC) comprising the steps of:
a) reacting poly(limonene)carbonate (PLC) with an epoxidation agent to form poly(limonene-8,9-oxide)carbonate (PLOC),
b) reacting the PLOC obtained in step a) with CO₂ to obtain PLDC. It has been found that the PLDC prepared according to this process has higher glass transition temperatures than the PLDC prepared with processes described in the prior art, where the PLOC was prepared from limonene dioxide rather than from PLC. This in turn improves the utility of the PLDC polymer in various applications, such as adhesives and packaging.

In another aspect, the present invention concerns the PLDC resulting from the process of the invention. In a further aspect, the invention concerns PLDC having a glass transition temperature of at least 150° C.

### BRIEF DESCRIPTION OF THE FIGURES

FIG. 1 shows the stainless steel high-pressure reactor (35 mL) used in the Examples, including the teflon insert of the reactor (15 mL).

FIG. 2 shows the HEL-multireactor system used in Example 3, including the 3 mL glass inserts.

FIGS. 3a and 3b show the thermogravimetric analysis of poly(limonene)carbonate prepared in Example 1 in accordance with the present invention.

FIGS. 4a and 4b show differential scanning calorimetry plots of poly(limonene)carbonate prepared in Example 1 in accordance with the present invention.

FIGS. 5a and 5b show the thermogravimetric analysis of poly(limonene-8,9-oxide)carbonate prepared in Example 2 in accordance with the present invention.

FIGS. 6a and 6b show differential scanning calorimetry plots of poly(limonene-8,9-oxide)carbonate prepared in Example 2 in accordance with the present invention.

FIGS. 7a, 7b, and 7c show the thermogravimetric analysis of poly(limonene)dicarbonate prepared in Example 3 in accordance with the present invention.

FIGS. 8a-8f show differential scanning calorimetry plots of poly(limonene)dicarbonate prepared in Example 3 in accordance with the present invention.

### DETAILED DESCRIPTION OF THE INVENTION

### Definitions

A/^{Me}

When referring to the amino-triphenolate catalyst

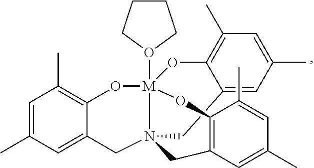

it will be referred to herein also as M^{Me}. In the case of having a central aluminium atom, it is referred to as Al^{Me}. In the case of having a central iron atom, it is referred to as Fe^{Me}.

### bis-triphenylphosphine iminium halide (Ph₃P═N⁺═PPh₃.X⁻)

When referring to bis-triphenylphosphine iminium halide, it will be referred to herein also as PPNhal, e.g. in the case of the chloride as PPNCI.

### LO, PLC, PLOC, and PLDC

The meaning of the terms “limonene oxide” (LO), “poly(limonene)carbonate” (PLC), “poly(limonene-8,9-oxide)carbonate” (PLOC), and “poly(limonene)dicarbonate” (PLDC) are known to the person skilled in the art. The structures of these compounds, shown without stereochemistry, are:

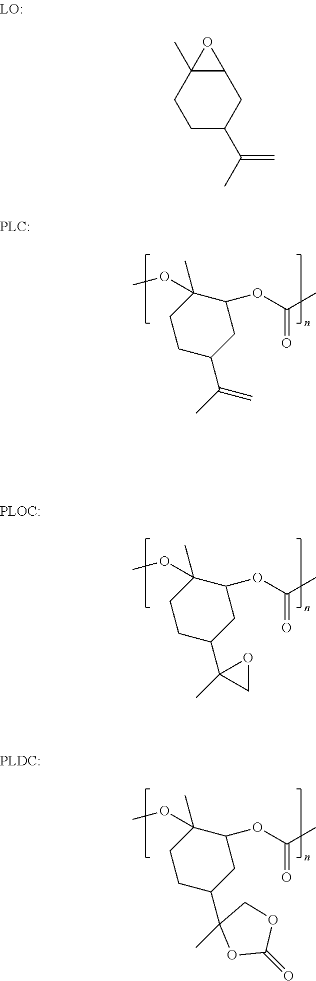

### Halide

Herein, the terms “halogen” and “halo” include fluoro, chloro, bromo, and iodo. Accordingly, “halide” includes fluoride, chloride, bromide, and iodide. In particular, chloride, bromide, and iodide are preferred.

Process

In one aspect, the present invention concerns a process for preparing poly(limonene)dicarbonate (PLDC) comprising the steps of:

a) reacting poly(limonene)carbonate (PLC) with an epoxidation agent to form poly(limonene-8,9-oxide)carbonate (PLOC),
b) reacting the PLOC obtained in step a) with CO₂ to obtain PLDC. The PLOC obtained in step a) may be isolated and/or purified before being used in step b).

Several reactions for the epoxidation of carbon-carbon double bonds to the corresponding epoxide are known in the art. These include the Jacobsen-Katsuki epoxidation, the Prilezhaev epoxidation, the Sharpless epoxidation, and the Shi epoxidation. The epoxidation agents used in these and other reactions are well known and include peroxy acids, hydrogen peroxide, sodium hypochlorite, and potassium peroxymonosulfate (Oxone®). Thus, in one embodiment, the epoxidation agent is selected from a group consisting of peroxy acids, hydrogen peroxide, sodium hypochlorite, and potassium peroxymonosulfate. In another embodiment, the epoxidation agent is a peroxy acid. In a further embodiment, the epoxidation agent is meta-chloroperoxybenzoic acid.

For the addition of CO₂ in step b) of the process according to the present invention, it has been found that it may advantageously be carried out in the presence of a halide catalyst. It has further been found that different halide catalysts provide satisfactory results. These include bis-triphenylphosphine iminium halide, such as bis-triphenylphosphine iminium chloride, ammonium halide, alkali metal halide, such as sodium bromide, and halides with β-diiminate complexes as disclosed by Li et al. (C. Li, R. J. Sablong and C. E. Koning, European Polymer Journal, 2015, 67, 449-458). In one embodiment, step b) is carried out in the presence of a halide catalyst. In another embodiment, step b) is carried out in the presence of bis-triphenylphosphine iminium halide as a catalyst. In a further embodiment, the bis-triphenylphosphine iminium halide is bis-triphenylphosphine iminium chloride. In still a further embodiment, step b) is further carried out in the presence of a Lewis acid, which may be in the form of a salt or a coordination complex of zinc, aluminium or iron. In a further embodiment, step b) is carried out in the presence of the amino-triphenolate co-catalyst having the formula:

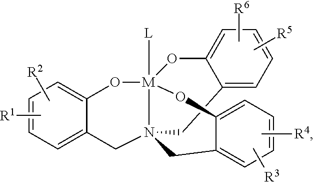

wherein M is Al or Fe, R¹, R², R³, R⁴, R⁵, and R⁶ are independently selected from the group consisting of hydrogen, C₁-C₆ alkyl, such as methyl, C₁-C₆ haloalkyl, C₁-C₆ alkyloxy, halogen, cyano, and nitro, and L is selected from the group consisting H₂O, tetrahydrofuran, and R—O—R′, R and R′ independently being C₁-C₆ alkyl. In one embodiment, the amino-triphenolate co-catalyst is M^{Me}. In yet a further embodiment, M is Al.

The steps of the process according to the present invention may be carried out using various solvents capable of dissolving the reactants of the different steps. Such solvents are typically polar aprotic solvents. Such solvents are apparent to the person skilled in the art and include dichloromethane, chloroform, tetrachloroethane, acetone, toluene, methyl ethyl ketone, acetonitrile, dimethysulfoxide, dimethylformamide and dimethylacetamide. Step b) may advantageously be carried out using methyl ethyl ketone as a solvent. Hence, in one embodiment, step b) is carried out in methyl ethyl ketone as a solvent.

The PLC reagent used in step a) of the process according to the present invention may in principle be obtained according to any process known in the art. Such processes include those disclosed by Byrne et al., Li et al., Hauenstein et al., Rieger et al., or Peña Carrodeguas et al. In one embodiment, the PLC used in step a) is obtained by reacting limonene oxide with CO₂ in the presence of a halide and the amino-triphenolate catalyst having the formula:

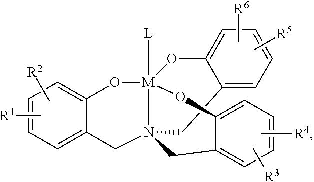

wherein M is Al or Fe, R¹, R², R³, R⁴, R⁵, and R⁶ are independently selected from the group consisting of hydrogen, C₁-C₆ alkyl, such as methyl, C₁-C₆ haloalkyl, C₁-C₆ alkyloxy, halogen, cyano, and nitro, and L is selected from the group consisting H₂O, tetrahydrofuran, and R—O—R′, R and R′ independently being C₁-C₆ alkyl, as co-catalyst. In a further embodiment, the amino-triphenolate is M^{Me}. In a further embodiment, the amino-triphenolate is Fe^{Me} or Al^{Me}. In yet a further embodiment, the halide is chloride. In another embodiment, the halide is bis-triphenylphosphine iminium halide. In yet another embodiment, the bis-triphenylphosphine iminium halide is bis-triphenylphosphine iminium chloride.

### PLDC Product

As discussed above, the PLDC obtained according to the process of the present invention has a higher glass transition temperature than the PLDC disclosed in the prior art. Accordingly, the process of the present invention leads to a new PLDC product. Thus, one aspect of the present invention concerns a PLDC obtainable by the process according to the present invention. In a further aspect, the invention concerns a PLDC having a glass transition temperature of at least 150° C. In one embodiment, the PLDC has a glass transition temperature of at most 250° C. In another embodiment, the PLDC has a glass transition temperature of at least 160° C. In yet another embodiment, the PLDC has a glass transition temperature of at least 170° C. In still another embodiment, the PLDC has a glass transition temperature of at most 240° C. In a further embodiment, the PLDC has a glass transition temperature of at most 230° C. In still a further embodiment, the PLDC has a glass transition temperature of at most 220° C. In yet a further embodiment, the PLDC has a glass transition temperature of at most 210° C.

### EXAMPLES

### Example 1—Synthesis of PLC

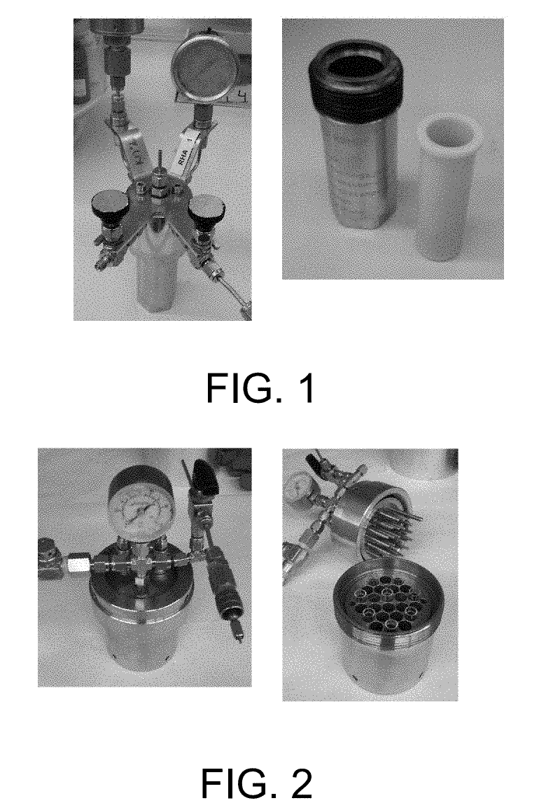

(+)-limonene oxide (4 mL, cis/trans mixture or cis), [Al^{Me}] (74 mg, 0.14 mmol) and PPNCI (40 mg, 70 μmol) were mixed in a Teflon vessel equipped with a magnetic stirring bar, placed in a stainless steel reactor (reactor and vessel shown in FIG. 1) and purged with 5 bar of CO₂ three times. Finally, the pressure was stabilized at 15 bar of CO₂ at room temperature. After placing the reactor in a metal heating block, the reactor was heated to an inside temperature of 45° C. for 48 h. The reaction was stopped by cooling down the reactor in an ice bath and subsequent depressurization. Analysis of the reaction mixture by ¹H NMR and mesitylene as an internal standard in CDCl₃ usually gave conversions of around 50%. To the dissolved mixture (in CDCl₃ or dichloromethane (DCM)), methanol (MeOH) was added dropwise until no further precipitation was observed. Finally, a few drops of water were added to complete precipitation. The obtained solid was isolated by decantation, suspended in MeOH and placed in an ultrasonic bath for up to half an hour. Solvation and precipitation was repeated at least once. The polymer was then dried in vacuo for 1 day. The lowest molecular weight polymer (Table 1, Entry 1) was obtained using a larger stainless steel reactor at larger scale (15 mL LO).

Table 1 summarizes the results obtained in the synthesis of PLC starting from different isomer mixtures of limonene oxide.

TABLE 1
Properties of different grades of PLC (GB = inert atmosphere
glove box) prepared according to this example.

| | | Synthetic | T_{d} (5%) | | Mₙ (kg | |
|---|---|---|---|---|---|---|
| Entry | Polymer | Remarks | (° C.) | T_{g} (° C.) | mol⁻¹) | M_{w}/Mₙ |
| 1 | PLC-1 | cis/trans, | 191 | 23 | 1.29 | 1.74 |
| | | 15 mL scale | | | | |
| 2 | PLC-2 | cis/trans | 243 | 83 | 3.13 | 1.27 |
| 3 | PLC-3 | GB, cis/trans | 222 | 110 | 9.92 | 1.27 |
| 4 | PLC-4 | GB, cis-LO | 198 | 96 | 4.21 | 1.28 |
| | | (+impurity) | | | | |
| 5 | PLC-5 | GB, cis-LO | 228 | 119 | 15.13 | 1.19 |

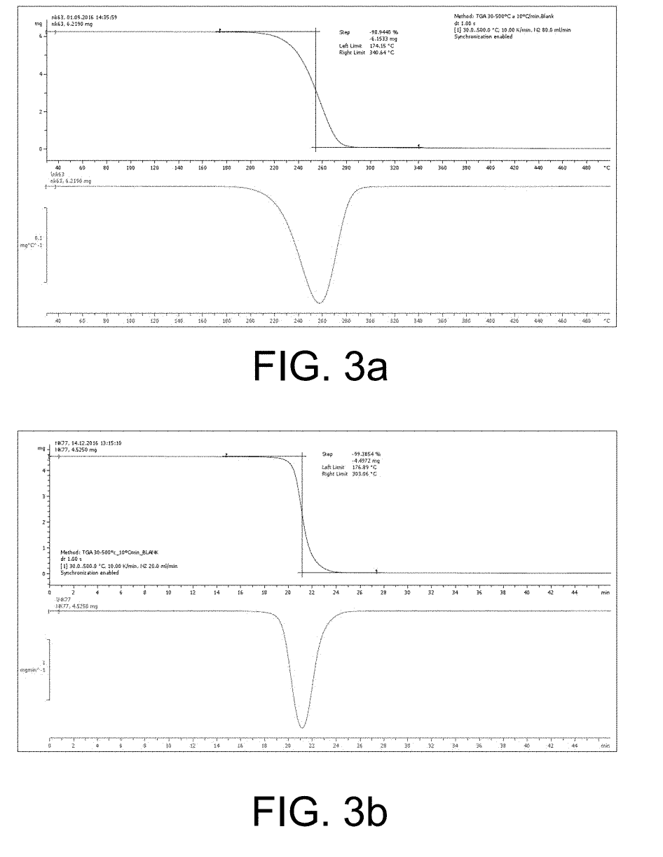

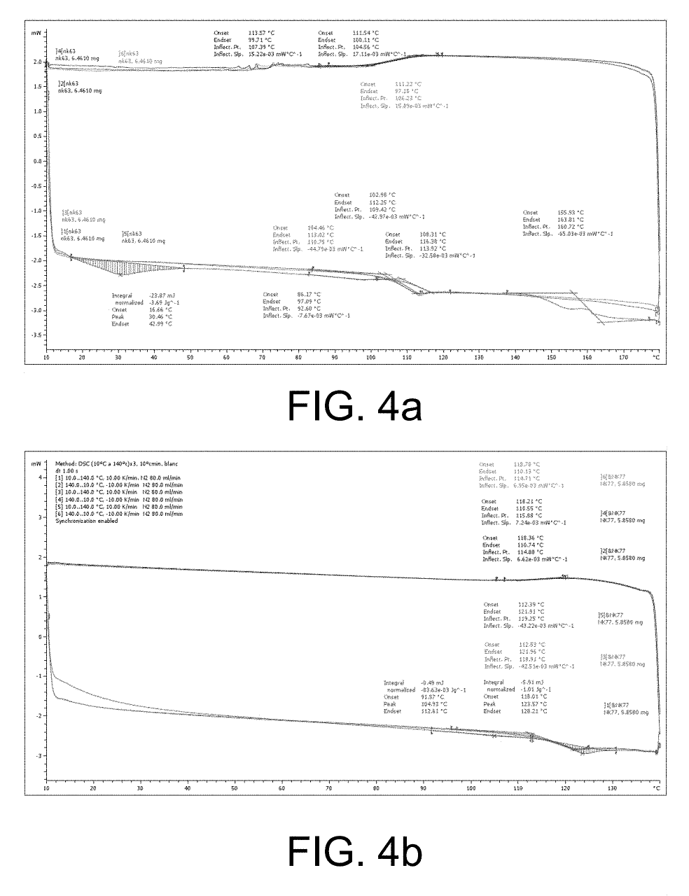

Thermal data (decomposition temperature) was obtained by differential scanning calorimetry/thermogravimetric analysis (DSC/TGA), polymer molecular weight (Mₙ) and dispersities (M_{w}/Mₙ) by gel permeation chromatography (GPC) measured against polystyrene (PS) standards with tetrahydrofuran (THF) as eluent at 25° C. T_{g} values (glass transition temperature) relate to the second heating run. FIGS. 3a and 3b show the TGA plots for entries 3 and 5, respectively, of Table 1. FIGS. 4a and 4b show the DSC plots for entries 3 and 5, respectively, of Table 1.

The NMR data for entry 5 are:

¹H NMR (CDCl₃, 400 MHz): δ (ppm)=5.09-5.03 (m, 1H), 4.73 (d, ²J_{HH}=7.4 Hz, 2H), 2.41 (d, ³J_{HH}=12.8 Hz, 1H), 2.25 (t, ³J_{HH}=12.1 Hz, 1H), 1.93-1.73 (m, 3H), 1.71 (s, 3H), 1.65-1.57 (m, 1H), 1.52 (s, 3H), 1.43-1.31 (m, 1H). ¹³C NMR (CDCl₃, 125 MHz): δ (ppm)=151.9, 148.6, 109.3, 81.8, 75.3, 37.4, 30.9, 30.6, 25.8, 21.5, 20.7.

### Example 2—Synthesis of PLOC

PLC (1.74 g, 8.88 mmol of alkene units) as prepared according to Example 1 was dissolved in DCM (50 mL) and the flask placed in an ice bath. Subsequently meta-chloroperoxybenzoic acid (m-CPBA) (3.07 g, 17.7 mmol) was added portion-wise as a solid. Stirring was continued for 12 h, whilst the mixture was allowed to slowly warm to room temperature. The formed suspension was filtered and then saturated Na₂SO₃ solution was added under vigorous stirring to quench the excess of m-CPBA. Phases were separated and saturated NaHCO₃ solution was added to the organic phase under vigorous stirring. After phase separation, the organic phase was washed with brine, dried over MgSO₄ and all volatiles were removed in vacuo. If necessary, the polymer was additionally purified by precipitating the polymer with MeOH from DCM or washing the solid polymer with MeOH in an ultrasonic bath.

TABLE 2
Properties of different grades of PLOC (P1-P5) prepared according
to Example 2.

| | | Conversion | | | | |
|---|---|---|---|---|---|---|
| | | in post- | T_{d} (5%) | | Mₙ (kg | |
| Entry | Polymer | modification | (° C.) | T_{g} (° C.) | mol⁻¹) | M_{w}/Mₙ |
| 1 | PLOC-1 | >99% | 197 | 47 | 1.38 | 1.75 |
| 2 | PLOC-2 | >99% | 222 | 109 | 2.96 | 1.29 |
| 3 | PLOC-3 | >99% | 215 | 131 | 9.91 | 1.31 |
| 4 | PLOC-4 | >99% | 224 | 118 | 4.37 | 1.31 |
| 5 | PLOC-5 | >99% | 208 | 135 | 16.51 | 1.47 |

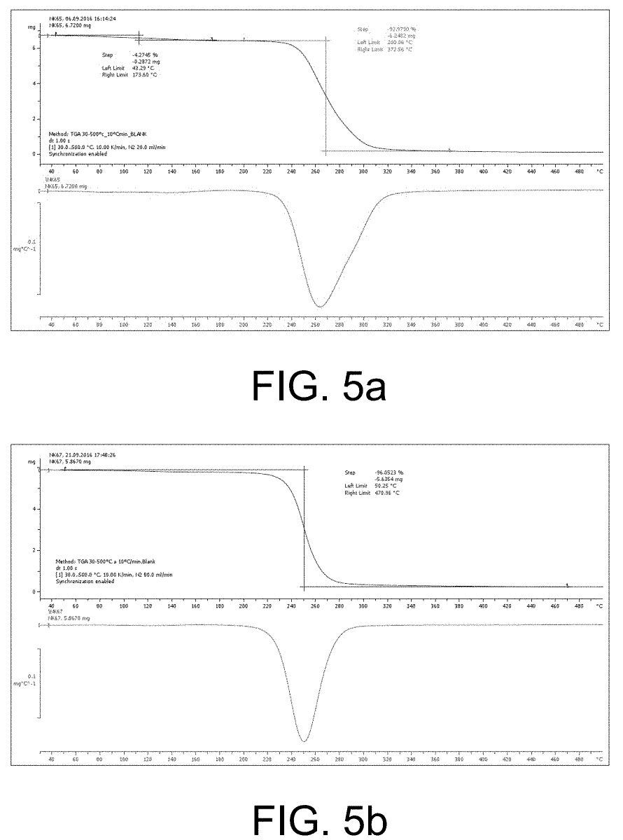

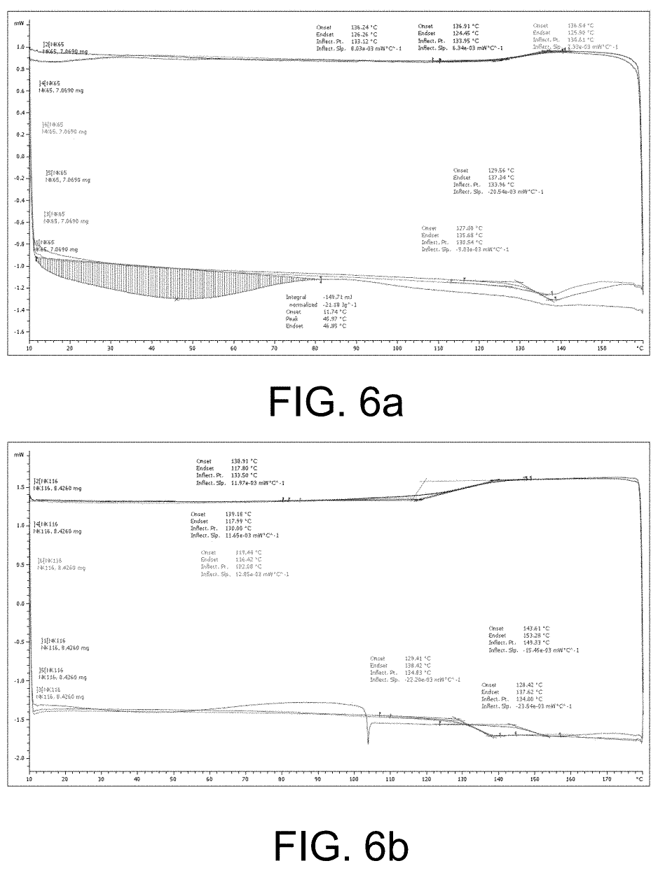

Thermal data was obtained by DSC/TGA, polymer molecular weight and dispersites by GPC measured against PS with THF as eluent at 25° C. T_{g} values relate to the second heating run. FIGS. 5a and 5b show the TGA plots for entries 3 and 5, respectively, of Table 2. FIGS. 6a and 6b show the DSC plots for entries 3 and 5, respectively, of Table 2.

The NMR data for entry 5 are:

¹H NMR (CDCl₃, 400 MHz): δ (ppm)=5.07-5.02 (m, 1H), 2.63-2.55 (m, 2H), 2.46-2.36 (m, 1H), 1.92-1.84 (m, 1H), 1.76-1.54 (m, 4H), 1.50 (s, 3H), 1.36-1.28 (m, 1H), 1.24 (s, 3H).

¹³C NMR (CDCl₃, 125 MHz): δ (ppm)=151.8, 81.8, 74.8, 58.7, 53.1, 36.5, 30.0, 27.9, 22.6, 21.5, 18.1.

### Example 3—Synthesis of PLDC

PLOC (200 mg, 940 μmol of epoxide units), PPNhal (94 μmol, 10 mol %) and solvent were mixed in a Teflon vessel equipped with a magnetic stirring bar, placed in a stainless steel reactor, purged three times with 5 bar of CO₂, and pressurized with 20 bar of CO₂ at room temperature. The mixture was heated to the desired temperature, as specified in Table 3, measured inside the reactor, and stirred for the time period specified in Table 3. After cooling down in an ice bath, the reactor was slowly depressurized. The liquid phase was transferred into a flask and the Teflon insert thoroughly rinsed with DCM. Removal of all volatiles in vacuum was followed by addition of DCM until the solid dissolved completely. Dropwise addition of MeOH gave a white to off-white precipitate. If necessary, the treatment was repeated to remove remaining PPNhal from the polymer. After drying in vacuum about 120-150 mg of the polymer could be isolated and used for further analysis.

TABLE 3
Optimization parameters for temperature and nucleophile
of the epoxide-to-carbonate post-modification in PLOC.

| | Temperature | | Reaction | Conversion | |
|---|---|---|---|---|---|
| Entry | (° C.) | PPNhal | time (h) | epoxide (%) | solvent |
| 1 | 53 | PPNCl | 72 | ~50 | MEK |
| 2 | 73 | PPNCl | 48 | >99 | MEK |
| 3 | 93 | PPNCl | 36 | >99 | MEK |
| 4 | 113 | PPNCl | 16 | >99 | Toluene |
| 5 | 73 | PPNBr | 72 | ~70 | MEK |
| 6 | 93 | PPNBr | 36 | >99 | MEK |
| 7 | 113 | PPNBr | 16 | >99 | Toluene |
| 8 | 93 | PPNI | 72 | ~70 | MEK |

Different combinations of Al^{Me} catalyst and PPNhal co-catalyst were also tested in the HEL multireactor with glass test tubes as inserts under the following conditions: 20 bar initial CO₂ pressure, 90° C., 24 h reaction time, MEK as solvent (0.24 M). These combinations gave the results indicated in Table 4:

TABLE 4
Optimization parameters for catalyst and co-catalyst of
the epoxide-to-carbonate post-modification in PLOC.

| | | | Loading | Conversion |
|---|---|---|---|---|
| | | | co-catalyst | epoxide |
| Entry | Catalyst | Co-catalyst | (mol %) | (%) |
| 1 | — | PPNCl | 5 | 80 |
| 2 | [Al^{Me}] | PPNCl | 5 | 99 |
| 3 | — | PPNBr | 5 | 63 |
| 4 | [Al^{Me}] | PPNBr | 5 | 82 |
| 5 | — | PPNI | 5 | 24 |
| 6 | [Al^{Me}] | PPNI | 5 | 44 |
| 7 | — | PPNCl | 10 | 95 |

### Synthesis of PLDC Using an Alternative Catalyst

PLOC (108 mg, 510 μmol of epoxide units), NaBr (6.3 mg, 61 μmol, 12 mol %) and N-methyl-2-pyrrolidone (NMP) (1.5 mL) were mixed in a Teflon inset of a stainless steel reactor, which was then pressurized with 25 bar of CO₂. Subsequently, the reactor was heated to 98° C. inside temperature (corresponding to 130° C. at the stirring plate) and stirred at this temperature for 16 h. After that, the reactor was placed in an ice bath and depressurized. To the dark brown liquid methanol was added dropwise, leading to the precipitation of a brown solid. Repeated cycles of dissolution (in DCM) and precipitation (from MeOH) led to the isolation of an off-white solid, which was dried in vacuum.

The properties of the PLDC's prepared in this example are provided below in Table 5:

TABLE 5
Properties of different grades of PLDC.

| | | Conversion | | | | |
|---|---|---|---|---|---|---|
| | Starting | in post- | T_{d} (5%) | | Mₙ (kg | |
| Entry | PLOC | modification | (° C.) | T_{g} (° C.) | mol⁻¹) | M_{w}/Mₙ |
| 1 | PLOC-1 | 95% | 233 | 152 | 1.48 | 1.38 |
| 2 | PLOC-2 | 90% | 221 | 154¹ | 3.87 | 1.18 |
| | | | | (150*) | | |
| 3 | PLOC-3 | >99% | 227 | 178* | 10.61 | 1.21 |
| 4 | PLOC-4 | >99% | 199 | 165* | 6.19 | 1.17 |
| 5 | PLOC-5 | >99% | 224 | 178* | 15.27 | 1.51 |
| 6 | PLOC-5 | >99% | 229 | 180* | 15.03 | 1.31 |

*Due to the edge temperature of 190° C. the glass transition temperature decreased significantly for every cycle. Despite this feature, the T_{g} value given refers to the second heating cycle.
¹Measured with an edge temperature of 180° C. PLDCs of entries 1-5 of Table 5 were prepared following the procedure of Table 3, entry 2.

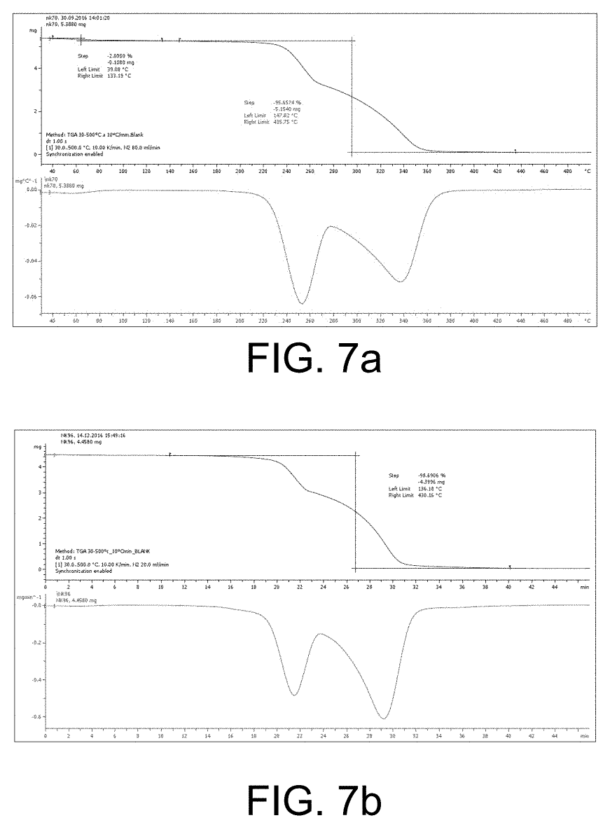

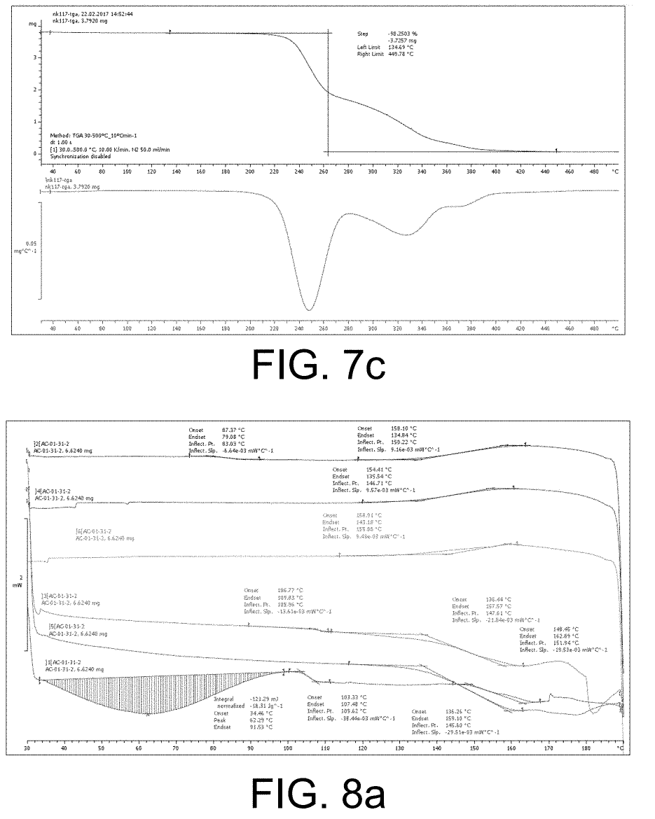

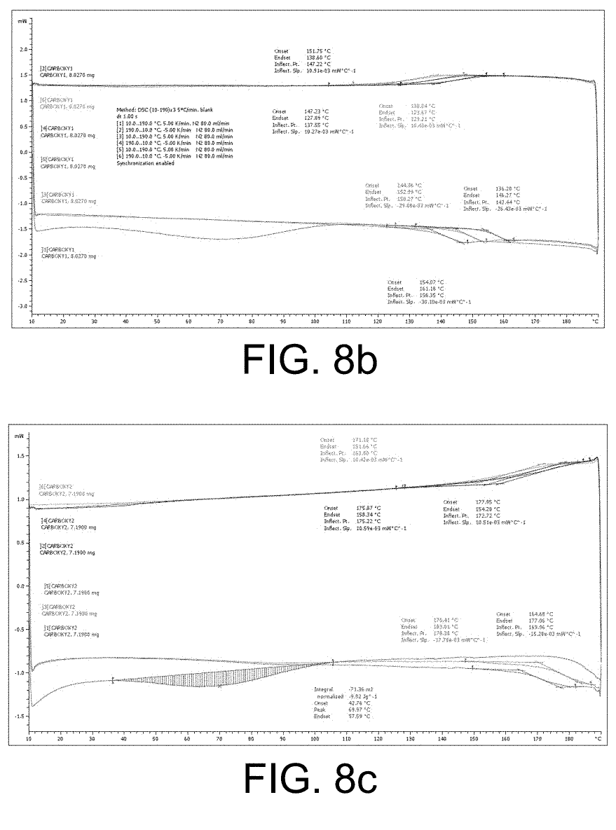

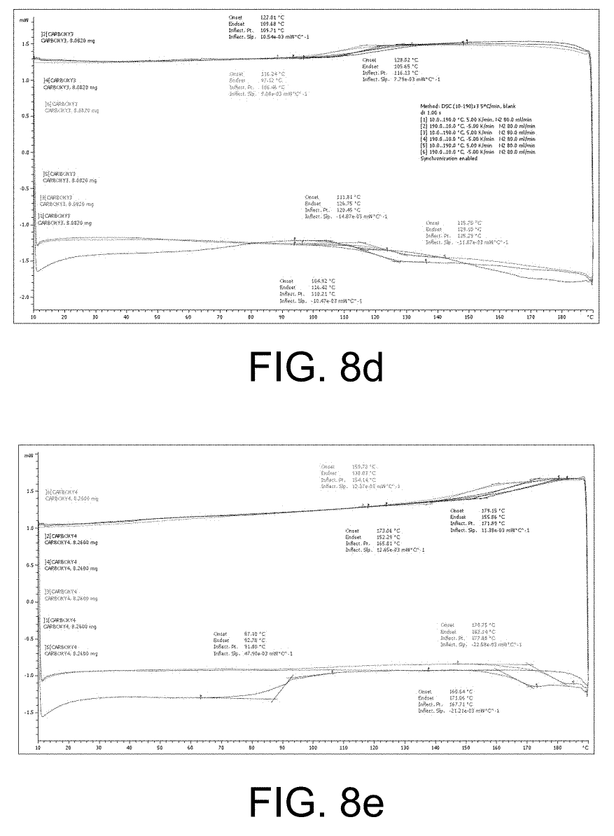

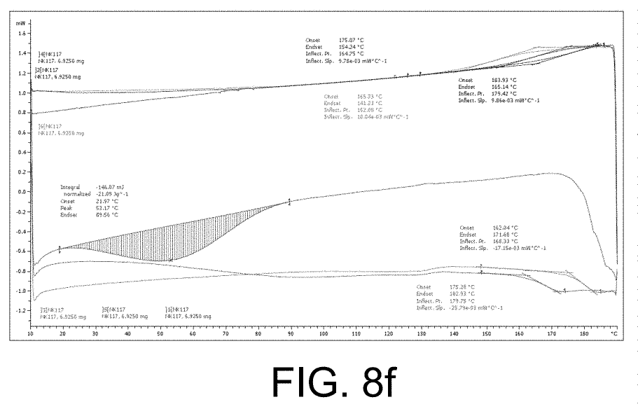

For entry 6, the conversion from PLOC to PLDC is carried out using the NaBr/NMP system as described above. Thermal data was obtained by DSC/TGA, polymer molecular weight and dispersities by GPC measured against PS standards with THF as eluent at 25° C. T_{g} values relate to the second heating run. FIGS. 7a, 7b, and 7c show the TGA plots for entries 3, 5, and 6, respectively, of Table 5. FIGS. 8a-8f show the DSC plots for entries 1 to 6, respectively, of Table 5.

The glass transition temperatures for entries 5 and 6 show that the high glass transition temperature achieved with the process of the present invention does not depend on the catalyst for the conversion from PLOC to PLDC. On the other hand, without being bound by a particular theory, it seems that the way PLOC is prepared does have an influence since the PLOC prepared from PLC according to the present invention leads to higher glass transition temperatures than if the PLOC has been prepared from limonene dioxide according to Li et al. (146° C.).

The NMR data for entry 5 of Table 5 are:

¹H NMR (CDCl₃, 400 MHz): δ (ppm)=5.27-5.16 (m, 1H), 4.34-4.26 (m, 1H), 4.12-4.10 (m, 1H), 2.49-2.29 (m, 1H), 2.05-1.86 (m, 2H), 1.80-1.59 (m, 3H), 1.53 (s, 3H), 1.50-1.44 (m, 3H), 1.41-1.25 (m, 1H).

¹³C NMR (CDCl₃, 125 MHz): δ (ppm)=154.4, 151.5, 84.9, 81.4, 74.2, 72.9, 38.2, 30.1, 26.1, 21.4, 22.8-20.5, 20.2.

1. A process for preparing poly(limonene)dicarbonate (PLDC) comprising:
a) reacting poly(limonene)carbonate (PLC) with an epoxidation agent to form poly(limonene-8,9-oxide)carbonate (PLOC), and
b) reacting the PLOC obtained in step a) with CO₂ to obtain PLDC.

2. The process according to claim 1 wherein step b) is carried out in the presence of a halide salt as a catalyst.

3. The process according to claim 1, wherein the epoxidation agent of step a) is meta-chloroperoxybenzoic acid.

4. The process according to claim 2, wherein step b) is carried out in the presence of bis-triphenylphosphine iminium halide as a catalyst.

5. The process according to claim 4, wherein the halide is chloride.

6. The process according to claim 2 wherein the halide salt is sodium bromide.

7. The process according to claim 4, wherein step b) is further carried out in the presence of the amino-triphenolate catalyst having the formula: 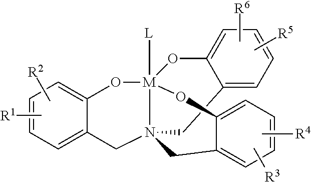
wherein M is Al or Fe, R¹, R², R³, R⁴, R⁵, and R⁶ are independently selected from the group consisting of hydrogen, and C₁-C₆ alkyl, and L is selected from the group consisting of H₂O, tetrahydrofuran, and R—O—R′, R and R′ independently being C₁-C₆ alkyl.

8. The process according to claim 7, wherein the amino-triphenolate catalyst has the formula: 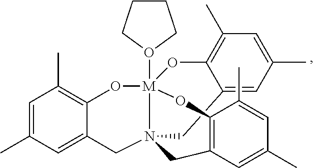
wherein M is Al or Fe.

9. The process according to claim 7, wherein M is Al.

10. The process according to claim 1, wherein step b) is carried out in methyl ethyl ketone as a solvent.

11. The process according to claim 1, wherein the PLC used in step a) is obtained by reacting limonene oxide with CO₂ in the presence of a halide and the amino-triphenolate catalyst having the formula: 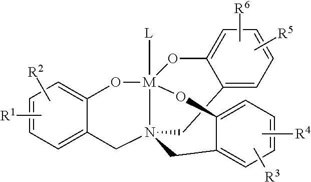
wherein M is Al or Fe, R¹, R², R³, R⁴, R⁵, and R⁶ are independently selected from the group consisting of hydrogen, and C₁-C₆ alkyl, and L is selected from the group consisting H₂O, tetrahydrofuran, and R—O—R′, R and R′ independently being C₁-C₆ alkyl.

12. The process according to claim 11, wherein the amino-triphenolate catalyst has the formula: 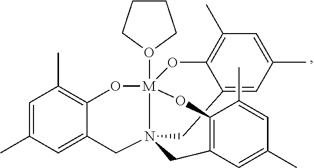
wherein M is Al or Fe, and the halide is bis-triphenylphosphine iminium halide.

13. The process according to claim 12, wherein M is Al.

14. The process according to claim 12, wherein the bis-triphenylphosphine iminium halide is bis-triphenylphosphine iminium chloride.

15. The PLDC obtainable by the process according to claim 1.

16. A poly(limonene)dicarbonate (PLDC) having a glass transition temperature of at least 150° C.

17. The PLDC according to claim 16 having a glass transition temperature of at most 250° C.

18. The PLDC according to claim 16 having a glass transition temperature of at least 160° C.

19. The PLDC according to claim 16 having a glass transition temperature of at least 170° C.

20. The PLDC according to claim 16 having a glass transition temperature of at most 220° C.
